(19) United States
(12) Patent Application Publication
(10) Pub. No.: US 2015/0363839 A1
(43) Pub. Date: Dec. 17, 2015

(54) Donation Per Email Open and Click in E-Mail, Charged to E-Mail Sender

(71) Applicant: Barry Zolty, Jackson, NJ (US)

(72) Inventor: Barry Zolty, Jackson, NJ (US)

(21) Appl. No.: 14/729,820

(22) Filed: Jun. 3, 2015

Related U.S. Application Data
(60) Provisional application No. 62/012,560, filed on Jun. 16, 2014.

(51) Int. Cl. G06Q 30/02; G06Q 10/10; G06Q 20/14; G06Q 20/10

(52) U.S. Cl. CPC G06Q 30/0279; G06Q 20/10; G06Q 10/107; G06Q 20/145

(57) ABSTRACT

Donating money to a charity by a sender of a message is carried out per opening of a received email and/or per selecting a link in a received message. This is done through a trusted system that is used by both a sender of a message, such as an email, and a recipient who recognizes that a message comes through the trusted system in embodiments of the disclosed technology.

### BACKGROUND

Mail systems are important for communication, whether on paper or electronic. In many mail systems, there is a fee per use. Either the sender pays, such us in the form of a purchase of a stamp, or the recipient pays, such as in the form of “cash on delivery” or paying to retrieve the item. Electronic systems work similarly. The cost to the sender is minimal to negligible, which poses the same problem as was experienced by early British mail systems, where the cost was borne by the recipient in the form of unsolicited and unwanted messages. While filters and devices which attempt to detect and remove such unwanted communications from the eyes of the recipient are well known, this shifts the cost to the recipient (or to his/her provider of an electronic mail account).

What is needed in the art is a way to shift the burden to the sender. This would decrease the amount of unwanted mail, and if the recipient knows that the sender paid a price for sending, the item being sent now becomes of greater interest and more valuable. Since the sender is sending to a recipient who now values the letter, the sender will have a better audience for his or her communication.

### SUMMARY OF THE DISCLOSED TECHNOLOGY

Funds are directed to a charity every time a user either opens an email or clicks on a link in the email in embodiments of the disclosed technology. A method of directing funds per electronic communication view to charity can include steps of receiving an email address and charity from a plurality of consumers at a network node. An email address can be any identifier used to designate a recipient of an electronic message. Funds can be received from an electronic letter sender. That is, something of monetary value is received or pre-received (before carrying out the letter dispatch) from someone who will send an electronic message.

Then an electronic communication from the electronic letter sender is transferred from one node on a network to another node on a network. As the message is electronic, there can be a link in the electronic message which, when selected, leads to yet another location on the network for retrieval of data. This can be a link to automatically view an image when the message is loaded, or a link which, as recited above, is selected in order to create a request to retrieve remote data.

Once the electronic communication is received, such as at a trusted server administering the process being described, a modified version can be sent via a network node to the plurality of consumers via their respective email addresses. The modified version can have a unique modification of each link of each message sent. Each of these unique modifications can direct to a second network node external to the electronic letter. Since the modifications are unique, it can now be ascertained, based on receipt at the second network node now associated with the link and the link data itself, that the link was selected by a consumer of the afore-described plurality of consumers. Then, a portion of the funds received from the message sender is directed to charity, the charity being selected by the consumer who viewed the electronic message. A “charity” is defined as a third party, other than the electronic communication sender, electronic communication recipient, or administrator. The “administrator” is one who is trusted by the sender and/or recipient to carry out, and/or does carry out one or more of the steps claimed as part of the disclosed technology.

The modified version of the electronic communication can have an image obtained from a unique link. In such an embodiment, transferring a portion of the funds to the charity selected by the consumer is based on (as a result of) an association between the unique link being used to access and/or retrieve and/or send data and the email address to which the electronic letter is sent. Since there are two different ways an electronic communication can be known to have been viewed by a certain consumer (based on an image shown or a link selected), funds can be sent for either of these actions with a greater amount of funds sent for both of these actions combined.

Expressed in another way, in a method of charging the sender of an electronic communication, this can be carried out by any or all of the following, in the order listed herein, or in any other order. A selection of a charity from each of a plurality of consumers is received. An electronic communication from a sender is also received. The sender and recipients are matched, with the recipient unknown to the sender in embodiments (e.g. completely anonymous). The electronic communication is received from the sender to be sent to the recipient or multiple recipients. This communication is sent after injecting (adding to the communication) each electronic communication with at least one string of data unique to each consumer of the plurality of consumers and each electronic communication. The injected code or data directs a device at a network node to retrieve data from a device at a different network node. One of the unique strings of data is then received at the different network node, and it is determined which consumer is associated therewith. Funds are transferred from the sender to a charity selected by the consumer. That is, each time a consumer views and/or clicks on a link in the email, the sender pays money to a charity selected by the recipient consumer.

The unique string of data can be a uniform resource locator and can be received upon selection thereof by a viewer of the electronic communication causing funds of the sender to be sent to the charity selected by the consumer. Or the unique string can be data with a link to an image to be displayed in the electronic communication and is received upon a viewer viewing the electronic communication, thereby causing funds of the sender to be sent to the charity selected by the consumer, based on the viewing thereof.

In trusted electronic communication systems, the email address of the consumer/end recipient of the electronic communication may be unknown to the sender. The link or code or modified data put into a communication desired to be sent by a sender can be a link to download data, such as a data file, image, or website. The sender and the consumer (recipient) can be matched based on mutual agreement, such as by way of selecting a group of people to send a message to and a category of senders (such as for profit, non-profit, personal) who send the message.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively such that the term “a and/or b” should be read to include the sets: “a and b,” “a or b,” “a,” “b.”

### BRIEF DESCRIPTION OF THE FIGS

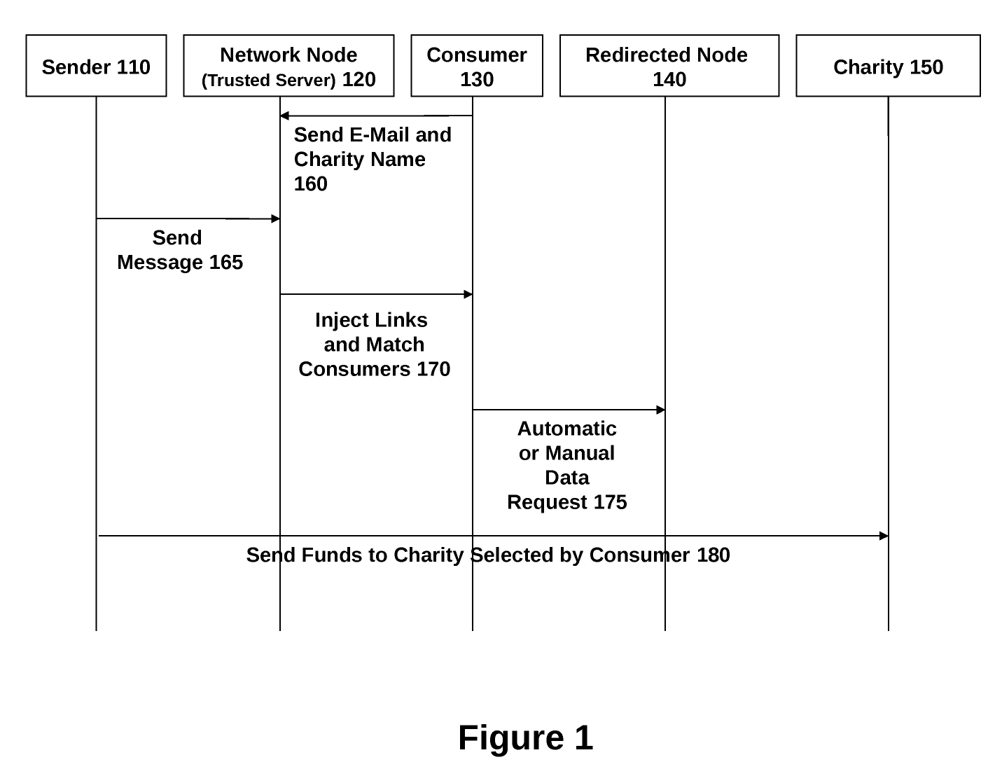

FIG. 1 shows a high level diagram of steps taken to carry out embodiments of the disclosed technology.

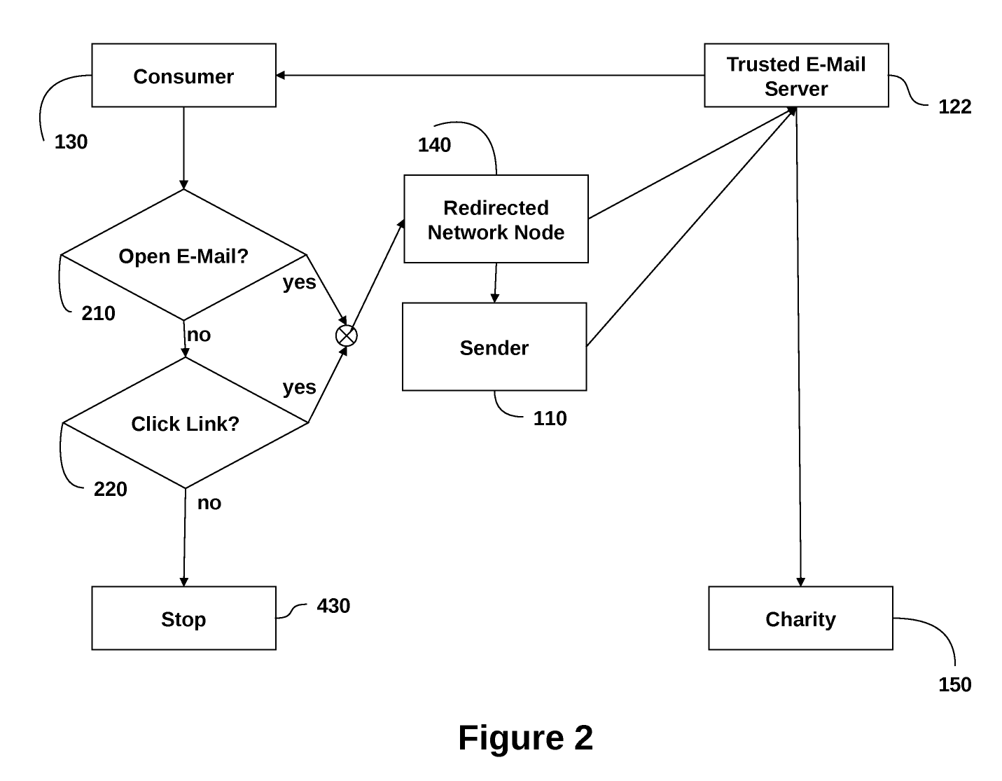

FIG. 2 shows a high level block diagram of devices used to carry out embodiments of the disclosed technology.

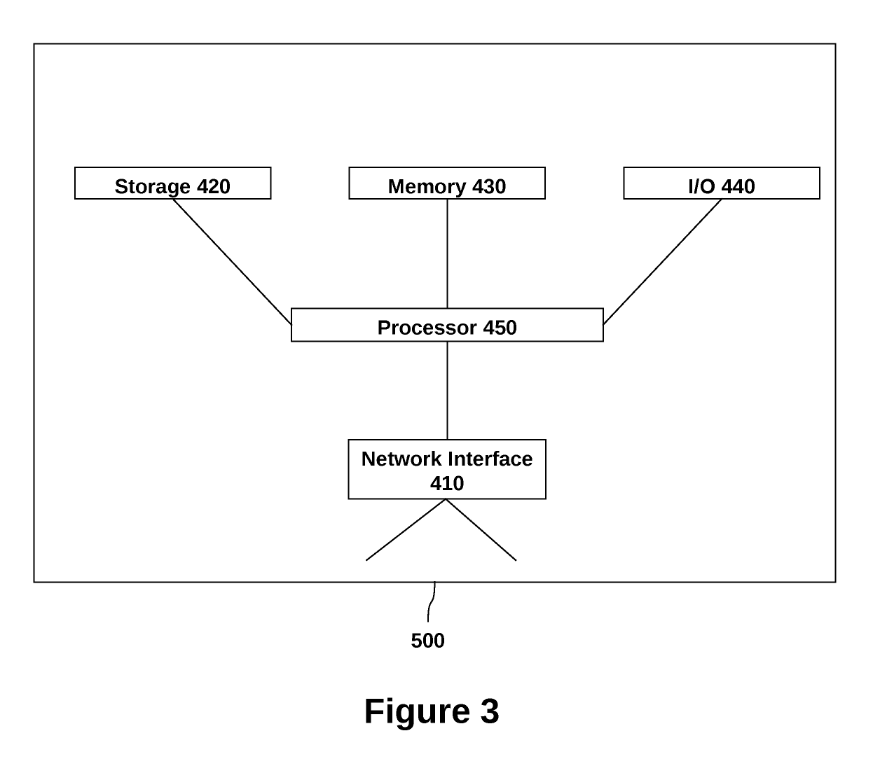

FIG. 3 shows a high-level block diagram of a mobile device that may be used to carry out the disclosed technology.

### DETAILED DESCRIPTION OF EMBODIMENTS OF THE DISCLOSED TECHNOLOGY

The technology disclosed allows email marketers to use a trusted system to send their emails. The trusted system is defined as, “an entity having a registered trademark name used in association with the email sending services which is marketed as such by the entity. The “entity” in this case is defined as an administrator or owner of the trademark, which also uses, owns, or encompasses at least one file server residing at a network node.”

Recipients of such emails receive an indication in the email subject line, and/or (inclusive) body with a “trackback” or traceable link for verification purposes, indicating that the email was sent using the trusted system. That is, the viewing of an email may be tracked by the display of a pixel or image which is downloaded from a server, and/or based on clicking in a link causing the user's web browser or other viewing mechanism to first send data to the trusted system before reaching a second location or data to be downloaded, as designated by the first party. The marketing, either in the email itself and/or (inclusive) in separate mediums (e.g., commercials, websites, advertisements) indicates that an email has been opened and/or (inclusive) any click on a link within the email will result in a donation by the e-mail sender to a particular charity. The “e-mail sender,” for purposes of this disclosure, is “a person or entity who pays the donation for a click in the email” and may also be “a person or entity who created or gave final approval of the contents of the email, excluding link redirection.” The actual email may be sent by a second party, such as the trusted system, which sends the email out to recipients.

In another embodiment, the email is sent by the email sender to the second party, which changes or provides the email redirection information, and sends same back to the email sender who does actually send the email to the intended recipients, such as those on a mailing list. In this manner, the trusted system has a copy of some or all emails being sent using its system, as well as links where parties which click there-on are redirected. As such, valid links may be verified with the trusted system when an email recipient clicks there-on, donations or monetary payments by the email sender can be tracked per link or disabled (such as when abuse is detected or after a pre-determined or any period of time).

Embodiments of the disclosed technology will become clearer in view of the following description of the figures.

FIG. 1 shows a high level diagram of steps taken to carry out embodiments of the disclosed technology. The ‘consumer’ 130 refers to the recipient of an email who displays a trackable image pixel or clicks on a trackable link. The ‘sender’ 110 is an entity of any type (personal, business (profit or non-profit), government) which sends an electronic communication, such as an e-mail. The ‘network node’ 120 is a physical network switch, router, or terminating device which receives and sends packets of data. This network node 120 may comprise an integrated or separate email server (residing at the same network node or another network node in communication therewith via a packet-switched network). The e-mail server sends mail in an electronic form and is improved as the e-mail server/network node now does more than just receive and send e-mail—it also carries out transactions from the email sender 110 to a designated entity of the recipient consumer 130. The redirected node 140 is another or same location on the network, as described above with reference to the network node 120. Finally, the charity 150 is an entity which accepts donations and is recognized as a non-profit institution by a government agency.

In the embodiment shown in step 160, the consumer creates an account with the trusted system and selects a charity 150. The sender 110 then sends a message in step 165, such as an email, directed to the network node 120. The network node 120/trusted server then modifies the message. This is done in step 170 to inject links into the content of the message itself. These links can be in the form of an image embedded in the message with a unique uniform resource locator referring to a file or data to be retrieved from the redirected node 140. Or, the links may be in the form of a link which must be selected by the consumer or viewer of the email which, when selected, redirects to the redirected node 140.

When an email is opened which passed through the trusted system (meaning, at least the links to advertisements or websites designated by the e-mail sender are directed first through the trusted system), and a link is clicked on by such a user, the e-mail sender is forced to donate a certain amount of money (e.g., 2 cents, 10 cents) to the charity selected by the consumer. This is carried out, as shown in step 175, with automatic (embedded image download) or manual (acting on a link) selection of an embedded data in the message, the embedded or injected data being placed there by the trusted server 120. The charity 150, having been selected by the consumer 130, now becomes the recipient of funds from the sender 110. This occurs in step 180 when funds are sent from the sender 110 to the charity 150. The funds can be a small amount, such as two cents or five cents per each email viewed. Still further, a consumer can conduct the automatic data request (such as opening an email with an embedded image) causing a first payment, such as 2 cents, then conduct the manual data request (such as clicking on a link) and cause as second payment, such as an additional 3 cents for a total of 5 cents. In this manner, the sender 110 pays per email view, and cost is shifted from the recipient to the sender.

Referring now to FIG. 2, this figure shows a high level block diagram of devices used to carry out embodiments of the disclosed technology. In embodiments, a specialized e-mail server is used. This e-mail server tracks messages from a sender 110, such as a “marketing entity user,” through the server. Such messages are sent to desired consumers 130 with a logo (such as a U.S. registered trademark or certification mark) of the trusted e-mail server to let a consumer know that, by viewing the email, his/her charity of choice 150 will be compensated. This sender 110 registers with the trusted system in order to send emails by way of the trusted system. Campaigns are organized and e-mail lists selected, which are either provided by the trusted system or the e-mail sender 110. It should further be understood that, in a single email, there may be multiple e-mail senders. That is, each one designates certain links and has a certain portion of the email for which they will ultimately pay a donation. In this manner, multiple e-mail senders (marketing entity users) may join together, so that their e-mail is more likely to be read, or a “newsletter,” such as sent by the trusted system, may contain offers and links from multiple marketing entity users. Further, the e-mail sender has access to tracking information and payment amounts to charity.

The tracking of clicks may be carried out using methods known in the art, such as JavaScript capturing of events using image tags and/or text links. Further, it should be understood that the system may be used outside of e-mail. That is, a link provided on a webpage, within a software application or the like, may be used in this manner to cause a person placing the link there to donate a certain amount to charity. This may occur with or without the person clicking on the link being previously registered with the trusted system, depending on the embodiment.

Referring still to FIG. 2, when the consumer opens an email in step 210, he/she can be directed to download data from the redirected network node 140 (based on injected code in the email). Or, the user, in step 220, can click on a link and, in the same manner, be redirected to the network node 140. This network node can then, in turn, redirect the consumer to the sender 110 to actually download the data, or can report on such actions to the sender. If the consumer does not open the email or click on the link, then no further steps are taken and a stop 430 is reached. On the other hand, when the redirected network node 140 is hit, then the trusted e-mail server (which can be operated by the same trusted system, device, or administrator as the redirected network node) is informed of same, and money from the sender 110 is sent to the charity 150 (at each click or in batches, such as when $10 or $100 are accumulated in click/viewing value). The charity 150 is the one selected by the consumer 130.

Describing now how a typical email server works and is modified and improved in embodiments of the disclosed technology, when a sender composes a message using his/her mail user agent, the sender sends to an improved mail server by way of an interface in a web browser or email address. When sending via e-mail, the POP or SMTP protocols, as known in the art, can be used. The improved email server sees the destination address, upon receipt, the sender address, message headers, and other data in an email and can verify the authenticity of the sender based on such information. Based on the sender and recipient email address, it is then determined which consumer or list of consumers should receive the message. The message itself is edited with injected code, as described above, and then sent to the appropriate consumers. When the email server receives a communication back, based on the consumer or person opening the message being redirected based on the injected code, it is determined from which email this code came. This communication takes place over a plurality of network nodes comprising hardware switches, routers, and electric cables using packets of data. Once it is determined which email caused the download of data (meaning, the email was opened and/or a link in the email was clicked on or otherwise selected), it is determined to which person (email address) this email was sent. Then, based on which charity was previously selected by this person, the improved functionality email server then directs funds from the message sender of this particular email to the appropriate charity.

FIG. 3 shows a high-level block diagram of a mobile device that may be used to carry out the disclosed technology. Computing device 400 comprises a processor 450 that controls the overall operation of the device by executing the device's program instructions which define such operation. The device's program instructions may be stored in a storage device 420 (e.g., magnetic disk, database) and loaded into memory 430 when execution of the console's program instructions is desired. Thus, the device's operation will be defined by the device's program instructions stored in memory 430 and/or storage 420, and the console will be controlled by processor 450 executing the console's program instructions.

The device 400 also includes one or a plurality of input network interfaces for communicating with other devices via a network (e.g., packet-switched data network). The device 400 further includes an electrical input interface for receiving power and data from a power source. A device 400 also includes one or more output network interfaces 410 for communicating with other devices. Device 400 also includes input/output 440, representing devices which allow for user interaction with a computing device (e.g., touch display, keyboard, fingerprint reader etc.). One skilled in the art will recognize that an implementation of an actual device will contain other components as well, and that FIG. 3 is a high level representation of some of the components of such a device for illustrative purposes. It should also be understood by one skilled in the art that the methods, systems and/or devices depicted in FIG. 1 or 2 may be implemented on a device such as is shown in FIG. 3.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

1. A method of directing funds per electronic communication view to charity comprising steps of:
receiving an email address and charity from a plurality of consumers at a network node;
receiving funds from an electronic letter sender;
receiving an electronic communication from said electronic letter sender at a network node, said electronic letter comprising at least one link to a network node external to said electronic letter;
sending a modified version of said electronic communication via a network node to said plurality of consumers via respective said email addresses, wherein said modified version comprises unique modification of each said link to direct to a second network node external to said electronic letter;
based on receipt at said second network node of said link, determining that said link was selected by a consumer of said plurality of consumers;
transferring a portion of said funds to said charity selected by said consumer.

2. The method of claim 1, wherein said modified version of said electronic communication further comprises an image obtained from a unique link; and
transferring a portion of said funds to said charity selected by said consumer, based on an association between said unique link and said email address where said electronic letter is sent.

3. The method of claim 2, wherein a first amount of said funds is sent to said charity when a single consumer of said plurality thereof views said image, and a second greater amount of said funds is sent to said charity when said single consumer activates said link.

4. The method of claim 1, carried out by a trusted system.

5. A method of charging the sender of electronic communication, comprising steps of:
receiving a selection of a charity from each of a plurality of consumers;
receiving said electronic communication from said sender to be sent;
sending said electronic communication to said plurality of consumers after injecting each said electronic communication with at least one unique string of data unique to each consumer of said plurality of consumers and each said electronic communication, wherein said injecting directs a device at a network node to retrieve data from a device at a different network node;
receiving one of said unique strings of data at said different network node and determining which consumer is associated therewith;
transferring funds from said sender to a charity selected by said consumer.

6. The method of claim 5, wherein said unique string of data comprises a uniform resource locator, and said unique string of data is received upon selection thereof by a viewer of said electronic communication, causing funds of said sender to be sent to said charity selected by said consumer.

7. The method of claim 6, wherein said unique string of data comprises a link to an image to be displayed in said electronic communication and is received upon a viewer viewing said electronic communication, thereby causing funds of said sender to be sent to said charity selected by said consumer based on said viewing.

8. A trusted electronic communication system comprising:
receiving registration of at least one consumer, said registration comprising at least an email address and the name of a charity;
receiving registration of an electronic message sender, comprising at least an email address;
receiving an electronic message at a network node designated to be sent to a receiver associated with said email address;
adding unique code into said electronic message referring to a location on a network for download of data;
sending said electronic message with said code to said consumer;
receiving a request to download said data with said code at said unique location on said network;
sending funds of said message sender to said charity received from said consumer.

9. The trusted electronic communication system of claim 8, wherein said code comprises a uniform resource locator associated with an image, and upon said image being displayed in said electronic communication, said funds of said message sender are allocated to said charity.

10. The trusted electronic communication system of claim 8, wherein said code comprises a clickable link and, upon said link being requested, said funds of said message sender are allocated to said charity.

11. The trusted electronic communication system of claim 10, wherein said registration is received for a plurality of said senders and a plurality of said consumers, and a plurality of electronic communications is sent, wherein each said code is unique and used to determine which sender of said plurality thereof and which charity associated with said consumer to transfer funds between.

12. The trusted electronic communication system of claim 8, wherein said email address of said consumer is unknown to said sender.

13. The trusted electronic communication system of claim 12, wherein said sender and said consumer are matched based on mutual agreement.
